(19) United States
(12) Patent Application Publication
(10) Pub. No.: US 2010/0243867 A1
(43) Pub. Date: Sep. 30, 2010

(54) MAPPING MECHANISM, FOUP AND LOAD PORT

(75) Inventors: Kensuke Suzuki, Toyohashi (JP); Toshio Kamigaki, Toyohashi (JP); Yasumichi Mieno, Toyohashi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SINFONIA TECHNOLOGY CO., LTD., Minato-ku (JP)

(21) Appl. No.: 12/749,106

(22) Filed: Mar. 29, 2010

(30) Foreign Application Priority Data
Mar. 27, 2009 (JP) 2009-080614

(51) Int. Cl. H01J 40/14

(52) U.S. Cl. 250/215

(57) ABSTRACT

Disclosed herein is a mapping mechanism for carrying out mapping for a FOUP which includes a wafer receiving section on which a plurality of wafers can be placed at a plurality of stages in a heightwise direction and a lid member mounted for opening and closing movement, including: a light emitting member and a light receiving member provided outside the FOUP; and a window member provided on a light path between the light emitting member and the light receiving member which can cross at least part of the wafers placed on the stage portions of the wafer receiving section; the light being caused to pass over all of the stages of the wafer receiving section of the FOUP to carry out the mapping for the FOUP.

### BACKGROUND OF THE INVENTION

1. Field of the Invention

This invention relates to a mapping mechanism for carrying out mapping for a FOUP (Front-Opening Unified Pod).

2. Description of the Related Art

In a fabrication process of semiconductors, processing of a wafer in a clean room is used in order to assure a high yield and high quality. However, in this day in which high integration of devices, refinement of circuitry and increase in size of wafers advance, it is difficult in terms of the cost and the technology to manage fine dust in the entire inside of the clean room. Therefore, in recent years, as a method which replaces the improvement in cleanness of the entire inside of the clean room, a countermeasure is adopted which introduces a “mini environment method” which improves the cleanness only in a local space around a wafer to carry out transportation and other processes of the wafer. In the mini environment method, a containment called FOUP (Front-Opening Unified Pod) for transporting and storing a wafer in a highly clean environment and a load port which is an apparatus in an interface section for carrying a wafer in a FOUP into and from a semiconductor fabrication apparatus and transferring the FOUP to and from a transport apparatus are utilized as significant apparatus. In particular, while particularly the inside of the FOUP and the inside of the semiconductor fabrication apparatus are in high cleanness in the clean room, the space in which the load port is disposed, or in other words, the outside of the FOUP and the semiconductor fabrication apparatus, has comparatively low cleanness so that the construction and operation costs of the clean room are suppressed.

Incidentally, before a wafer in a FOUP is fed to a semiconductor fabrication apparatus, a mapping process of recognizing or mapping the number or presence/absence or accommodation posture of a plurality of wafers stacked in a plurality of stages in the FOUP is carried out. A mapping mechanism for carrying out such a mapping process as just mentioned is usually provided in a load port, and after a lid member of the FOUP is opened, a sensor section of the mapping mechanism is inserted into the FOUP to detect presence/absence, inclination or an overlap of wafers.

However, such a mapping mechanism as described above has a problem in that the mapping process requires much time because, when the mapping process is carried out, a step of opening the lid member of the FOUP is required without fail.

Thus, also a mapping mechanism which can carry out a mapping process without opening the lid member of a FOUP has been proposed. For example, Japanese Patent Laid-Open No. 2000-277590 (hereinafter referred to as Patent Document 1) discloses a mode of an apparatus wherein a wafer detecting door is provided on a side wall of a FOUP such that it does not damage the air-tightness of the inside of the FOUP. Further, a comb-shaped detection sensor having a plurality of transmission type sensors provided at a predetermined pitch in the heightwise direction thereof is inserted through the wafer detecting door. Then, in a state wherein the transmission type sensors are inserted in gaps between wafers, it is detected whether or not sensor light is intercepted to detect presence/absence of wafers. Meanwhile, Japanese Patent Laid-Open No. 2005-64515 (hereinafter referred to as Patent Document 2) discloses another mode of an apparatus wherein an image pickup system including a camera and a radiation source is disposed on the proximity of a FOUP and presence/absence of a wafer is detected depending upon whether or not the camera detects light irradiated from the radiation source and reflected by a wafer. Further, Japanese Patent Laid-Open No. 2005-64055 (hereinafter referred to as Patent Document 3) discloses a further mode of an apparatus wherein a pair of reflection type optical sensors are provided on a door member of a load port such that, upon upward and downward movement of the door member, light is irradiated from the reflection type optical sensors and presence/absence or an inclination of a wafer is detected depending upon whether or not reflected light from a wafer is received by both of the reflection type optical sensors or whether or not such reflected light is received by only one of the reflection type optical sensors.

### SUMMARY OF THE INVENTION

However, in the mode disclosed in Patent Document 1, since the wafer detecting door is pressed by the detection sensors every time a mapping process is carried out, there is the possibility that the sensors themselves may be damaged by the load and so forth upon such pressing, and it is difficult to maintain a appropriate mapping processing function for a long period of time. Further, the provision itself of the transmission type sensors in a comb-like arrangement in the heightwise direction gives rise to complication of the structure. Thus, there is another problem that, if the accuracy of the pitch of the transmission sensors is low, then the transmission type sensors may be brought into contact with wafers to disable an appropriate mapping process.

Meanwhile, in the mode disclosed in Patent Document 2, since the image pickup system is essentially required, a high cost is required. Further, since light radiated from the radiation source and reflected by a wafer is detected by the camera, if the reflection factor is different depending upon the type of wafers, then the detection of light is likely to be influenced by this. Therefore, there is a problem that the accuracy and reliability of the mapping process are deteriorated by the influence. Further, also with the mode disclosed in Patent Document 3 which uses a pair of reflection type sensors, if the type or the like of wafers changes and also the reflection factor changes, then it is likewise difficult to carry out a mapping process always with a high degree of accuracy.

Therefore, it is a principal object of the present invention to provide a mapping mechanism which can carry out a mapping process appropriately without opening a lid member of a FOUP and can achieve simplification in structure and suppression of unnecessary increase of the cost.

According to an aspect of the present invention, there is provided a mapping mechanism for carrying out mapping for a FOUP which includes a wafer receiving section on which a plurality of wafers can be placed at a plurality of stages in a heightwise direction and a lid member mounted for opening and closing movement, including a light emitting member and a light receiving member provided outside the FOUP, and a window member provided on a light path between the light emitting member and the light receiving member which can cross at least part of the wafers placed on the stage portions of the wafer receiving section, the light being caused to pass over all of the stages of the wafer receiving section of the FOUP to carry out the mapping for the FOUP. It is to be noted that, in the present invention, although the window member on the FOUP passes light therethrough, the internal space of the FOUP cannot be opened.

Here, the “wafer receiving section on which a plurality of wafers can be placed at a plurality of stages in a heightwise direction” signifies in other words that the wafer receiving section has a plurality of stage portions in the heightwise direction and a wafer can be placed at each of the stage portions.

With the mapping mechanism described, since light irradiated from the light emitting member provided outside the FOUP passes through the window member provided on the FOUP and is received by the light receiving member provided outside the FOUP, when a mapping process is carried out, there is no necessity to open the lid member of the FOUP. Consequently, the operation efficiency and the operation speed enhance. Further, with the mapping mechanism, since there is no necessity for a detection sensor to press a wafer detecting door, such a situation that the light emitting member and the light receiving member are damaged by a load upon pressing does not occur at all. Therefore, an appropriate mapping processing function can be maintained for a long period of time. Besides, since the sensor itself is formed from the light emitting member and the light receiving member, when compared with the alternative mode wherein light reflected by a wafer is detected, a mapping process can be carried out with a high degree of accuracy without being influenced by the reflection factor which may differ among different wafers. Consequently, a mapping processing result having high reliability can be obtained.

The mapping mechanism may further include reflection means for reflecting the light outputted from the light emitting member between the light emitting member and the light receiving member so that the light can be inputted to the light receiving member, the window member and the reflection means being provided on the lid member of the FOUP. With the mapping apparatus of the configuration described, when the lid member is opened to carry wafers into and out of the FOUP, interference of the wafers with the reflection means can be prevented with certainty. Consequently, inadvertent damage to the wafers when the wafers are carried into and out of the FOUP can be prevented.

Particularly, the mapping mechanism may be configured such that the light emitting member and the light receiving member are provided on a door member of a load port which receives the FOUP thereon and carries wafers accommodated in the FOUP between a predetermined semiconductor fabrication apparatus and the FOUP, the door member facing the lid member of the FOUP to open and close the lid member by upward and downward movement thereof. With the mapping apparatus having the configuration described, the distance between the light receiving member and light emitting member and the wafers can be made as short as possible, and consequently, the accuracy of the mapping process can be raised. In this instance, if the light emitting member and the light receiving member are provided integrally with the door member which is movable in the heightwise direction such that the light emitting member and the light receiving member carry out upward or downward movement together with upward or downward movement of the door member, then a mechanism for exclusive use for moving only the light emitting member and the light receiving member upwardly and downwardly is not required. Consequently, also simplification of the structure can be implemented effectively.

According to another aspect of the present invention, there is provided a FOUP including a wafer receiving section capable of receiving a plurality of wafers placed at a plurality of stage portions thereof in a heightwise direction, and a lid member mounted for opening and closing movement, a light path between a light emitting member and a light receiving member provided outside the FOUP being set to a position at which the light path can cross at least part of the wafers placed at the stage portions of the wafer receiving section through the lid member, the lid member having a window member provided on the light path thereon for allowing light to pass therethrough. With the FOUP having the configuration described, similar or substantially similar advantages to those achieved by the mapping mechanism described above can be achieved. In particular, since, when a mapping process is carried out, there is no necessity to open the lid member, the operation efficiency and the operation speed enhance. Further, an appropriate mapping process can be maintained for a long period of time.

According to a further aspect of the present invention, there is provided a load port which can receive a FOUP including a wafer receiving section capable of receiving a plurality of wafers at a plurality of stages therein in a heightwise direction and is adapted to carry the wafers accommodated in the FOUP received thereon between the inside of a predetermined semiconductor fabrication apparatus and the inside of the FOUP, including a light emitting member and a light receiving member for forming therebetween a light path which passes through a window member, which is provided in the FOUP for allowing light to pass therethrough, and can cross at least part of the wafers placed on the stage portions of the wafer receiving section. With the load port having the configuration described, similar or substantially similar advantages to those of the mapping mechanism can be achieved, and a mapping process for a FOUP can be carried out rapidly and accurately.

According to the present invention, a mapping mechanism can be provided which can carry out a mapping process for a FOUP rapidly and accurately without opening the lid member of the FOUP and can achieve simplification in structure and suppression of unnecessary increase of the cost.

### BRIEF DESCRIPTION OF THE DRAWINGS

FIG. 1 is a plan view schematically illustrating a relative positional relationship of a load port and a semiconductor fabrication apparatus in a clean room according to a first embodiment of the present invention;

FIG. 2 is a schematic side elevational view of the load port to which a mapping mechanism according to the first embodiment is applied and a FOUP;

FIG. 3 is a schematic front elevational view of the load port shown in FIG. 2;

FIG. 4 is a schematic view illustrating an operation principle of the mapping mechanism shown in FIG. 2;

FIG. 5 is a schematic side elevational view of a load port to which a mapping mechanism according to a second embodiment of the present invention is applied and a FOUP; and

FIG. 6 is a schematic view illustrating an operation principle of the mapping mechanism shown in FIG. 5.

### DETAILED DESCRIPTION OF THE PREFERRED EMBODIMENTS

In the following, embodiments of the present invention are described with reference to the accompanying drawings.

### First Embodiment

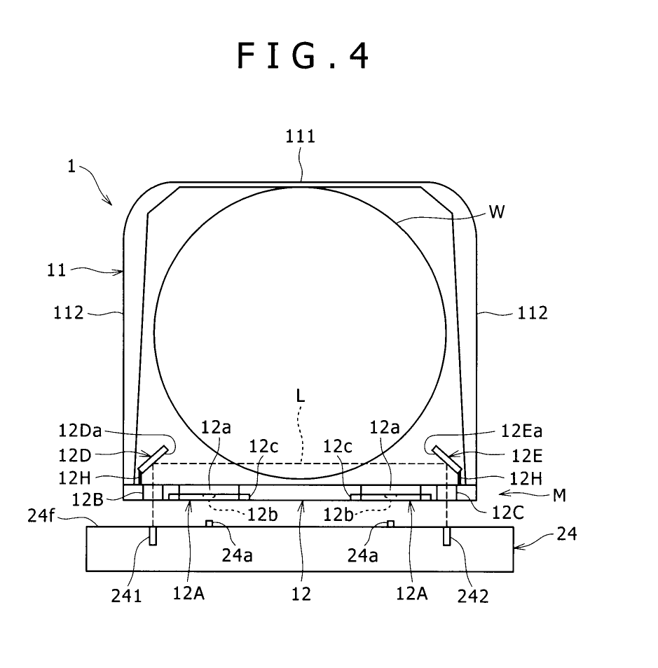

A mapping mechanism M according to a first embodiment of the present invention carries out mapping for a FOUP 1 and includes a light emitting member 241 and a light receiving member 242 provided on a load port 2, and a window member such as a first window member 12B and a second window member 12C provided on a light path L between the light emitting member 241 and the light receiving member 242 in the FOUP 1 as seen in FIG. 4.

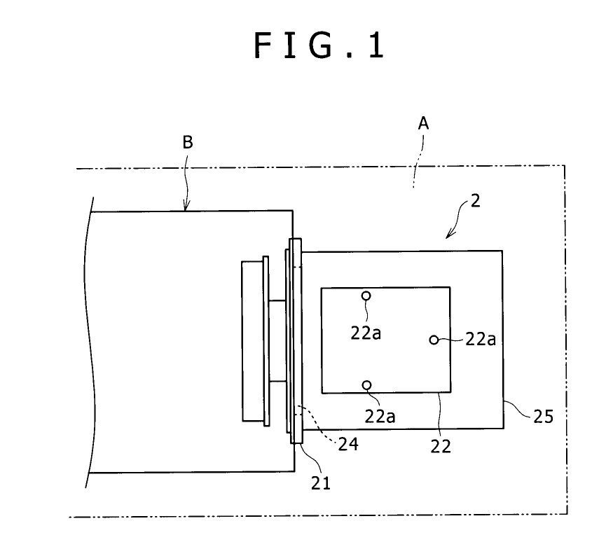

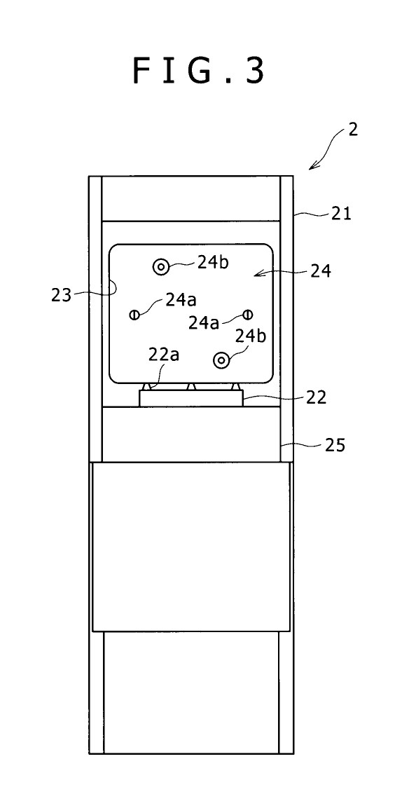

The load port 2 is used in a fabrication process of semiconductors and is disposed in the proximity of a semiconductor fabrication apparatus B in a common clean room A as seen in FIGS. 1 to 3. The load port 2 is closely contacted with a lid member 12 of the FOUP 1 to open and close the lid member 12 and carries a wafer W between the inside of the FOUP 1 and the inside of the semiconductor fabrication apparatus B. FIG. 1 is a plan view showing the load port 2 and associated members as viewed from above and schematically illustrates a relative positional relationship between the load port 2 and the semiconductor fabrication apparatus B in the clean room A. The load port 2 has a function of discharging wafers W accommodated in the FOUP 1 into the semiconductor fabrication apparatus B and accommodating the wafers W processed by the semiconductor fabrication apparatus B into the FOUP 1. By the configuration described, while the inside of the semiconductor fabrication apparatus B and the inside of the FOUP 1 are maintained in high cleanness in the clean room A while the space in which the load port 2 is disposed, that is, the outside of the semiconductor fabrication apparatus B and the FOUP 1, can be placed in comparatively low cleanness.

Referring to FIGS. 1 to 4, the load port 2 includes a frame 21 having a form of a substantially rectangular plate and disposed in a substantially vertical posture, and a receiving plate 22 provided in a substantially horizontal posture at a position rather upwardly of a central portion of the frame 21 in the heightwise direction. The load port 2 further includes an opening 23 having a lower edge set at a heightwise position of the frame 21 substantially same as the receiving plate 22 and capable of communicating with the inside of the semiconductor fabrication apparatus B, and a door member 24 for opening and closing the opening 23. The receiving plate 22 is supported on a support table 25 which extends forwardly from a front face of the frame 21. The receiving plate 22 has three projections 22a formed thereon in such a manner as to project upwardly. The projections 22a are engaged with holes not shown formed on the bottom of the FOUP 1 to position the FOUP 1 on and with respect to the receiving plate 22.

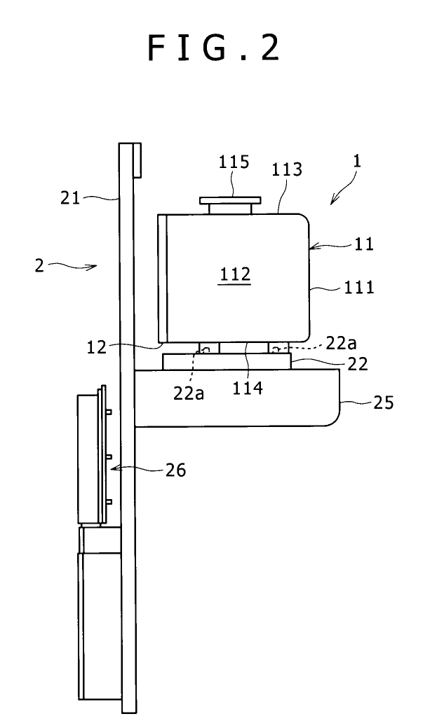

The door member 24 is upwardly and downwardly movable in the heightwise direction. When the door member 24 moves upwardly and downwardly in a state wherein it closely contacts with the lid member 12 provided on the rear face of the FOUP 1 with the FOUP 1 placed on the receiving plate 22, it can open and close the lid member 12. On the other hand, the door member 24 by itself can move upwardly and downwardly in a state wherein it is positioned in the proximity of the lid member 12 of the FOUP 1 with the FOUP 1 placed on the receiving plate 22. The door member 24 includes a pair of engaging pawls 24a for engaging with engaging holes 12b of latch members 12A provided on the lid member 12, and a pair of suction pads 24b capable of attracting the lid member 12 to the door member 24. It is to be noted that a door opening and closing mechanism 26 for opening and closing the door member 24 is provided on the load port 2 as seen in FIG. 2.

Further, in the present embodiment, the light emitting member 241 and the light receiving member 242 which construct a photoelectric sensor are provided on the door member 24 as seen in FIG. 4. The light emitting member 241 and the light receiving member 242 are provided at the equal height and at positions spaced by an equal distance from a central position in a widthwise direction toward the opposite side edges of the door member 24. In the present embodiment, the light emitting member 241 and the light receiving member 242 are provided at positions displaced to the side edges with respect to the engaging pawls 24a. Further, the light emitting member 241 and the light receiving member 242 are attached integrally to the door member 24 such that tip ends thereof may be in flush with or substantially in flush with a forwardly directed face 24f of the door member 24. Further, the direction of the light emitting member 241 is set so that irradiation light from the light emitting member 241 may advance perpendicularly or substantially perpendicularly to the widthwise direction of the door member 24. Meanwhile, the direction of the light receiving member 242 is set so that light receiving member 242 may detect light reflected toward a perpendicular direction or substantially perpendicular direction to the widthwise direction of the door member 24 by reflecting mirrors, that is, a first reflecting mirror 12D and a second reflecting mirror 12E hereinafter described. In the present embodiment, the light emitting member 241 and the light receiving member 242 are disposed at a location in the proximity of an upper end portion of the door member 24 in a closed state, or more particularly, at a heightwise position at which a wafer W at the uppermost stage from among a plurality of wafers W accommodated in the FOUP 1 placed on the receiving plate 22. The light emitting member 241 and the light receiving member 242 can move downwardly by downward movement of the door member 24 to successively detect all of the wafers W from the wafer W at the uppermost stage to the wafer W at the lowermost stage accommodated in the FOUP 1.

Meanwhile, the FOUP 1 includes a substantially box-shaped FOUP body 11 which is open only rearwardly, and a lid member 12 capable of closing up the rear opening of the FOUP body 11. The FOUP body 11 integrally has a front wall 111, a pair of left and right side walls 112, a top wall 113 and a bottom wall 114, which cooperatively define an internal space which serves as a shelf section or wafer receiving section (not shown) which can receive a plurality of wafers W placed at a plurality of stages and at a predetermined pitch thereon. This shelf section has a plurality of stage portions in a heightwise direction and can receive a wafer at each of the stage portions. The shelf section has a substantially cylindrical shape open forwardly and rearwardly and has a plurality of slits provided on side walls thereof at a predetermined pitch such that each of them can support an edge portion of a wafer W. Consequently, a plurality of wafers can be received at different stages in a heightwise direction with edges of the wafers W placed therein. Boundary portions between the walls 111, 112, 113 and 114 which form the FOUP body 11 have a moderately curved shape. Further, a flange portion 115 for being grasped by a transport apparatus (OHT: Over Head Transport) is provided at a central portion of an upwardly directed face of the top wall 113.

The lid member 12 can face the door member 24 of the load port 2 and generally has a form of a plate. The lid member 12 has a pair of left and right latch members 12A provided thereon for locking the lid member 12 to the FOUP body 11. Each of the latch members 12A is of a known type and includes a rotatable plate 12a mounted for rotation around a horizontal axis, an engaging hole 12b formed at the center of the rotatable plate 12a, and a latch body 12c movable between a locking position at which it can engage with a latch hole not shown provided on the top wall 113 and the bottom wall 114 of the FOUP body 11 and an unlocking position at which the engagement with the latch hole is canceled by rotation of the rotatable plate 12a. In the present embodiment, the left and right latch members 12A are provided at positions of the lid member 12 spaced by an equal distance from the central position in the widthwise direction toward the side edges of the lid member 12.

Windows, particularly a first window member 12B and a second window member 12C, are provided at positions of the lid member 12 different from those of the latch members 12A. More particularly, the first window member 12B and the second window member 12C are provided at positions displaced toward the side edges from the latch members 12A but displaced to the center side in the widthwise direction from the inner faces of the side walls 112 of the FOUP body 11. The first window member 12B and the second window member 12C are disposed at positions of the lid member 12 at which they can face the light emitting member 241 and the light receiving member 242, respectively, in a state wherein the FOUP 1 is placed on the receiving plate 22 of the load port 2. The first window member 12B and the second window member 12C are formed from a material having a light transmitting property, that is, from a transparent material such as, for example, polycarbonate, and extend linearly along the heightwise direction of the lid member 12 and are attached integrally to the lid member 12. It is to be noted that also it is possible to removably attach the first window member 12B and the second window member 12C to the lid member 12 such that, when they are brought into a state wherein they cannot exhibit intended transparency any more due to damage thereto or time-dependent variation thereof, they can be replaced with new window members.

The FOUP 1 of the present embodiment includes a first reflecting mirror 12D and a second reflecting mirror 12E provided between the light emitting member 241 and the light receiving member 242 at positions on an imaginary straight line crossing a portion of an edge of a wafer W displaced toward the lid member 12 side at which they do not interfere with the edge of the wafer W. The first reflecting mirror 12D and the second reflecting mirror 12E serve as reflection means for reflecting light outputted from the light emitting member 241 so that it can be inputted to the light receiving member 242. In the present embodiment, the reflection means, that is, the first reflecting mirror 12D and the second reflecting mirror 12E, are provided on the lid member 12 of the FOUP 1. In particular, the reflection means, that is, the first reflecting mirror 12D and the second reflecting mirror 12E, are supported by a pair of arms 12H provided on a face of the lid member 12 facing the front wall 111 of the FOUP 1 so as to project toward the FOUP body 11 side. Thus, in the mapping mechanism M of the present embodiment, the first reflecting mirror 12D and the second reflecting mirror 12E have arrangement angles set such that light outputted from the light emitting member 241 advances into the FOUP 1 through the first window member 12B and is reflected by the reflecting face 12Da of the first reflecting mirror 12D so as to cross an edge of a wafer W as viewed in plan, whereafter it is reflected by the reflecting face 12Ea of the second reflecting mirror 12E and advances to the outside of the FOUP 1 through the second window member 12C and then is inputted to the light receiving member 242. It is to be noted that, in order to make it possible to adjust the angle of the reflecting faces of the reflecting minors, that is, the first reflecting mirror 12D and the second reflecting mirror 12E, with respect to the lid member 12, the reflecting mirrors, that is, the first reflecting mirror 12D and the second reflecting mirror 12E, may be supported for pivotal motion around a vertical axis or may be supported for movement in a direction of a horizontal plane. The reflecting mirrors, that is, the first reflecting mirror 12D and the second reflecting mirror 12E, extend in the heightwise position in the FOUP 1 such that they are set at an upper end thereof to a position higher than a wafer W placed at the uppermost stage in the FOUP 1 and at a lower end thereof to a position lower than a wafer W placed at the lowermost stage. Further, the reflecting mirrors, that is, the first reflecting mirror 12D and the second reflecting mirror 12E, are located such that, when wafers W are discharged to the outside of the FOUP 1 or returned into the inside of the FOUP 1 with the lid member 12 opened, the wafers W may not interfere with any of the reflecting mirrors, that is, the first reflecting mirror 12D and the second reflecting mirror 12E.

Now, a procedure and operation where a mapping process is carried out by such a mapping mechanism M as described above are described.

First, a FOUP 1 is placed on the receiving plate 22 of the load port 2 by the transport apparatus. Thereupon, holes not shown formed on the bottom face of the FOUP 1 are fitted with the projections 22a provided on the receiving plate 22 so that the FOUP 1 is placed in a relatively positioned state on the receiving plate 22. In this state, or in a state wherein the FOUP 1 is moved in an approaching direction to the door member 24 by a slide mechanism not shown provided on the receiving plate 22, the mapping mechanism M outputs or emits signal light from the light emitting member 241. This signal light traces the light path L described hereinabove. particularly, the signal light traces the light path L such that it first passes through the first window member 12B formed in the lid member 12 of the FOUP 1 and is reflected by the reflecting face 12Da of the first reflecting mirror 12D such that the signal light thereafter can cross an edge of a wafer W as viewed in plan. As a result, if wafers W are accommodated or placed in a normal posture at the stages, that is, in the slits, of the shelf section in the FOUP 1, then the signal from the light emitting member 241 interferes with an edge of a wafer W. Consequently, the amount of the light which can be detected by the light receiving member 242 when the signal light suffering from the interference is reflected by the reflecting face 12Ea of the second reflecting mirror 12E and passes through the second window member 12C formed in the lid member 12 of the FOUP 1 is smaller than the amount of the light when the light is emitted or may be zero. On the other hand, if no wafer W exists in the FOUP 1, then the signal light from the light emitting member 241 traces the light path L which crosses an edge of a wafer W as viewed in plan without interfering with an edge of a wafer W. Therefore, the amount of the signal light which can be detected by the light receiving member 242 when the signal light not suffering from interference is thereafter reflected by the reflecting face 12Ea of the second reflecting mirror 12E and passes through the second window member 12C is equal to or substantially equal to the amount of the light when the signal light is emitted. Accordingly, by moving the door member 24 downwardly while the signal light is continuously outputted or emitted from the light emitting member 241 to move the light emitting member 241 and the light receiving member 242 downwardly with respect to the FOUP 1, the light can be passed along the FOUP 1 over all of the stages of the shelf section of the FOUP 1 thereby to carry out mapping for the FOUP 1. More particularly, by causing the light to pass along the light path L over all of the stages of the shelf section of the FOUP 1, the mapping mechanism M can detect, based on the variation of the amount of light received by the light receiving member 242 and the variation of time for which the light is received by the light receiving member 242, whether or not a wafer W is placed at each stage portion provided on the shelf section in the FOUP 1, whether or not the wafers W are inclined or whether or not a plurality of wafers W are placed one on another.

After the mapping process is completed in accordance with the procedure described above, the FOUP 1 is further moved in the approaching direction toward the door member 24 by the slide mechanism not shown provided on the receiving plate 22, and then the lid member 12 is attracted by the suction pads 24b of the door member 24. At this point of time, the engaging pawls 24a of the door member 24 are engaged with the engaging holes 12b of the lid member 12 and are turned to rotate the rotatable plates 12a, whereupon the latch bodies 12c are moved from the locking position to the unlocking position. As a result, the lid member 12 is placed into a state wherein it can be removed from the FOUP body 11. Then, the lid member 12 is moved rearwardly toward the load port 2 side and then moved downwardly to open the opening 23. In this state, those of the wafers W in the FOUP 1 from which any abnormal state has not been detected at the mapping step are successively fed into the semiconductor fabrication processing apparatus by a wafer W feeding apparatus, that is, a feeding robot, not shown provided in the semiconductor fabrication apparatus. Then, after the semiconductor fabrication processing step is completed, the wafers W are accommodated back into the FOUP 1.

In this manner, since the mapping mechanism M according to the present embodiment includes the light emitting member 241 and the light receiving member 242 provided outside the FOUP 1 and the first window member 12B and the second window member 12C provided on the light path L, which crosses at least part of a wafer W placed on each of the stage portions of the shelf section of the FOUP 1, between the light emitting member 241 and the light receiving member 242 for allowing light to pass therethrough, it can carry out a mapping process with the lid member 12 of the FOUP 1 kept closed. Consequently, in comparison with any other mode wherein it is necessary to open the lid member 12 when a mapping process is carried out, the time required for the mapping process itself and the time required before the mapping process is started can be reduced. Further, in comparison with the existing mode which uses an image pickup system, simplification of the structure and reduction of the cost can be achieved effectively. Further, in comparison with the mode which uses a pair of reflection type sensors, an influence of the reflection factor which differs among different wafers W can be eliminated, and an appropriate mapping process can be carried out based on the variation of the amount of light passing through the window members 12B and 12C provided in the FOUP 1 and detected by the light receiving member 242.

Particularly since the light emitting member 241 and the light receiving member 242 are provided on the load port 2, after the mapping process is completed, a process of discharging the wafers W into the semiconductor fabrication apparatus can be carried out smoothly. Besides, since the light emitting member 241 and the light receiving member 242 are provided on the door member 24 of the load port 2 which faces the lid member 12 of the FOUP 1, the spatial distance between the light receiving member 242 and light emitting member 241 and the wafer W can be made as short as possible, and the accuracy of the mapping process can be raised. Further, since also the light emitting member 241 and the light receiving member 242 move together with the upward and downward movement of the door member 24, a mechanism for exclusive use for moving only the light emitting member 241 and the light receiving member 242 upwardly and downwardly is unnecessary, and also simplification in structure can be achieved effectively.

Further, according to the mapping mechanism M of the present embodiment, since the window members 12B and 12C are formed on the lid member 12 of the FOUP 1 which is flat and the light emitting member 241 and the light receiving member 242 are disposed in a direction perpendicular or substantially perpendicular as viewed in plan to the flat upright faces of the window members 12B and 12C, such a situation that light is refracted by a great amount when it passes through the window members 12B and 12C can be eliminated, and consequently, an accurate mapping process can be carried out. Further, according to the mapping mechanism M of the present embodiment, since also the reflection means, that is, the reflecting mirrors 12D and 12E, for reflecting light outputted from the light emitting member 241 so that it can be inputted to the light receiving member 242 is provided on the lid member 12 of the FOUP 1 between the light emitting member 241 and the light receiving member 242, when the lid member 12 is opened and wafers W are carried into and out of the FOUP 1, interference of the wafers W with the reflection means, that is, with the reflecting mirrors 12D and 12E, can be prevented with certainty. Consequently, when wafers W are carried into and out of the FOUP 1, inadvertent damage to the wafers W can be prevented.

### Second Embodiment

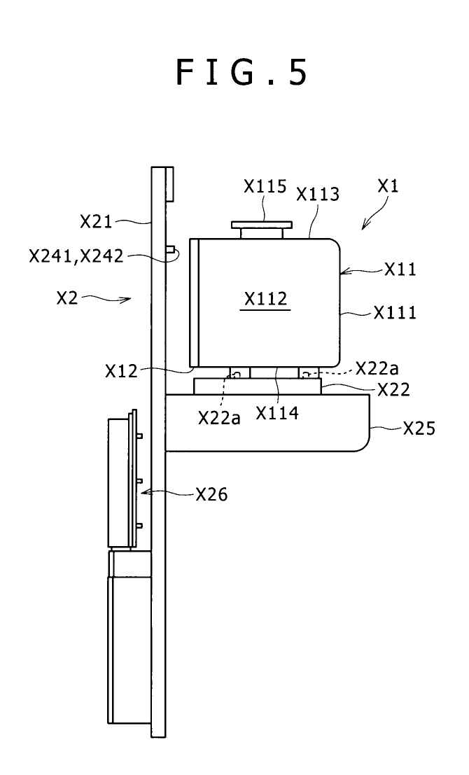

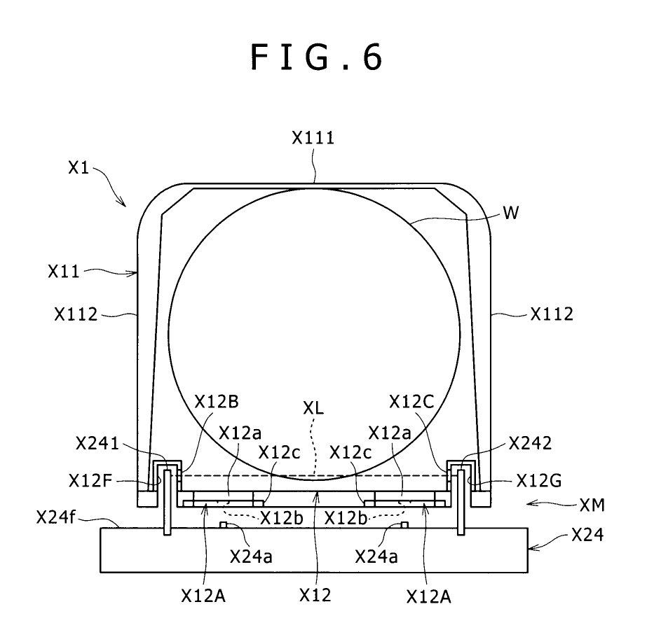

A mapping mechanism XM according to a second embodiment of the present invention is similar to the mapping mechanism M according to the first embodiment in that a light emitting member X241 and a light receiving member X242 are provided on a door member X24 of a load port X2 as seen in FIGS. 5 and 6 but is different in the following points. In particular, the light emitting member X241 and the light receiving member X242 project forwardly from a front face of the door member X24, that is, toward the FOUP X1 side. Further, a pair of recessed portions, that is, a first recessed portion X12F and a second recessed portion X12G, are formed on the lid member X12 of the FOUP X1 such that the light emitting member X241 and the light receiving member X242 projecting from the front face of the door member X24 can be inserted into the recessed portions, that is, the first recessed portion X12F and the second recessed portion X12G, respectively, and the window portions, that is, the first window member X12B and the second window member X12C, are formed at least at portions of the lid member X12 at which the recessed portions, that is, the first recessed portion X12F and the second recessed portion X12G, face the other window members, that is, the second recessed portion X12G and the first recessed portion X12F. It is to be noted that, in the following description and FIGS. 5 and 6, like or corresponding elements to those of the first embodiment are denoted by like reference symbols with a prefix “X” added thereto and overlapping description of them is omitted herein to avoid redundancy.

In particular, the light emitting member X241 and the light receiving member X242 can have tip end portions thereof positioned in the recessed portions, that is, in the first recessed portion X12F and the second recessed portion X12G, of the FOUP Xl, respectively, at least upon mapping. The light emitting member X241 and the light receiving member X242 may be configured to allow back and forth movement, folding movement or expanding and contacting movement in a direction in which the tip end portions thereof can be moved toward and away from the door member X24. In the mapping mechanism XM of the present embodiment, the light emitting member X241 irradiates light in a direction parallel to the widthwise direction of the lid member X12.

Meanwhile, the recessed portions provided on the lid member X12 of the FOUP X1, that is, the first recessed portion X12F and the second recessed portion X12G, are recessed toward the front wall X111 side of the FOUP X1 and are formed continuously in the heightwise direction of the FOUP X1. Further, window members, that is, a first window member X12B and a second window member X12C, are provided on upright walls X12Fa and X12Ga of the recessed portions X12F and X12G which oppose to the other ones of the recessed portions X12F and X12G, respectively. The first window member X12B and the second window member X12C are made of a transparent material such as, for example, polycarbonate and are individually provided over the overall area in the heightwise direction of the recessed portions X12G and X12F, respectively. It is to be noted that also it is possible to removably attach the window members X12B and X12C to the lid member 12 such that, when they are brought into a state wherein they cannot exhibit intended transparency any more due to damage thereto or time-dependent variation thereof, they can be replaced with new window members. In the present embodiment, the first window member X12B and the second window member X12C are provided at positions on an imaginary line crossing a portion of an edge of a wafer W displaced toward the lid member X12 side at which they do not interfere with the edge of the wafer W nor with the stage portions of the shelf section described above. In the second embodiment having such a configuration as described above, the requirement for the reflection means used in the first embodiment, that is, for the first reflecting mirror 12D and the second reflecting mirror 12E, is eliminated. Further, the mapping mechanism XM of the present embodiment is set such that light outputted from the light emitting member 241 can advance into the FOUP X1 through the first window member X12B, cross an edge of a wafer W which may be placed on a stage portion of the shelf, advance to the outside of the FOUP X1 through the second window member X12C and then be inputted to the light receiving member X242. In short, as apparently seen also from FIG. 6, a light path XL formed between the light emitting member X241 and the light receiving member X242 traces a straight line which extends in parallel or substantially in parallel to the widthwise direction of the lid member X12.

Now, a procedure and operation where a mapping process is carried out by such a mapping mechanism XM as described above are described.

First, the FOUP X1 transported to a position above the receiving plate X22 of the load port X2 by the transport apparatus is positioned on and width respect to the receiving plate X22 through engagement of the holes not shown formed on the bottom face thereof with the projections X22a provided on the receiving plate X22. At this point of time or at a point of time at which the FOUP X1 is moved in a direction toward the door member X24 by the slide mechanism not shown provided on the receiving plate X22, the mapping mechanism XM exhibits a state wherein the tip end portions of the light emitting member X241 and the light receiving member X242 are inserted in the first recessed portion X12F and the second recessed portion X12G, respectively. Then, signal light is outputted from the light emitting member X241. This signal light traces the light path XL along which it passes through the first window member X12B provided in the first recessed portion X12F of the FOUP X1 and can cross an edge of a wafer W placed on a stage portion of the shelf section. As a result, if wafers W are accommodated in a normal posture in the FOUP X1, then the signal light from the light emitting member X241 interferes with an edge of a wafer W. Consequently, the amount of the light which passes through the second window member X12C provided in the second recessed portion X12G and can be detected by the light receiving member X242 is smaller than the amount of the light when the light is emitted or may be zero. On the other hand, if no wafer W exists in the FOUP 1, then the signal light from the light emitting member X241 traces the light path XL which crosses an edge of a wafer W as viewed in plan without interfering with an edge of a wafer W. Therefore, the amount of the signal light which passes through the second window member X12C and is detected by the light receiving member X242 is equal to or substantially equal to the amount of the light when the signal light is emitted. Accordingly, by moving the door member X24 downwardly while the signal light is continuously outputted or emitted from the light emitting member X241 to move the light emitting member X241 and the light receiving member X242 downwardly with respect to the FOUP X1, the mapping mechanism XM can detect, based on the variation of the amount of light received by the light receiving member X242 and the variation of time for which the light is received by the light receiving member X242, whether or not a wafer W is placed at each stage portion provided on the shelf section in the FOUP X1, whether or not the wafers W are inclined or whether or not a plurality of wafers W are placed one on another.

In this manner, also with the mapping mechanism XM according to the present embodiment, similar or substantially similar effects to those achieved by the mapping mechanism M according to the first embodiment described hereinabove can be achieved. Further, since the light path XL formed between the light emitting member X241 and the light receiving member X242 traces a simple straight line which crosses an edge of a wafer W, the mapping accuracy can be further raised. Furthermore, since there is no necessity to provide reflection means, that is, a reflecting mirror, on the lid member, also simplification in structure can be anticipated.

It is to be noted that the present invention is not limited to the embodiments described above. For example, each window member is preferably formed not on a somewhat rounded face, that is, on a curved face, of the FOUP but on a flat face of the FOUP. In particular, each window member may be provided on a flat face which does not extend perpendicularly or substantially perpendicularly to the advancing direction of light outputted from the light emitting member or to the advancing direction of light to be inputted to the light receiving member, or in another words, on a flat face inclined as viewed in plan with respect to the advancing direction of light.

Further, each window member may naturally be made of a material other than polycarbonate such as, for example, an acrylic resin or tempered glass. Or a mode wherein the reflection means is attached to a portion of the FOUP other than the lid member such as, for example, the FOUP body through a supporting member such as an arm or is attached directly in the inside of the FOUP without through a supporting member, for example, to the FOUP body, may be adopted. Where a mapping mechanism which includes reflection means is adopted, the following configuration may be adopted. In particular, the light emitting member and the light receiving member are provided at the same position of the load port. For example, also the light receiving member is provided at the position at which the light emitting member 241 is provided in FIG. 4. In this instance, a single window member is provided on the lid member such that light outputted from the light emitting member passes through the window member and crosses at least part of a wafer placed at a stage portion of the wafer receiving section. Then, the light is reflected by reflection means, which may be, for example, a single reflecting mirror, such that it thereafter traces the same light path but reversely such that it passes through the window member and is inputted to the light receiving member. In this instance, the light path between the light emitting member and light receiving member and the reflection means preferably extends in parallel or substantially in parallel to the depthwise direction of the FOUP.

Also the particular configuration of the other part is not limited to that of the embodiments described above but can be modified in various forms without departing from the subject matter of the present invention.

The present application contains subject matter related to that disclosed in Japanese Priority Patent Application JP 2009-080614 filed with the Japan Patent Office on Mar. 27, 2009, the entire content of which is hereby incorporated by reference.

What is claimed is:

1. A mapping mechanism for carrying out mapping for a Front-Opening Unified Pod (FOUP) which includes a wafer receiving section on which a plurality of wafers can be placed at a plurality of stages in a heightwise direction and a lid member mounted for opening and closing movement, said mechanism comprising:
a light emitting member and a light receiving member provided outside the FOUP; and
a window member provided on a light path between said light emitting member and said light receiving member, the light path crossing at least part of the wafers placed on the plurality of stages of the wafer receiving section,
light outputted from said light emitting member being caused to pass over all of the stages of the wafer receiving section of the FOUP to carry out the mapping for the FOUP.

2. The mapping mechanism according to claim 1, further comprising:
a reflector to reflect the light outputted from said light emitting member between said light emitting member and said light receiving member so that the light can be inputted to said light receiving member, said window member and said reflector being provided on the lid member of the FOUP.

3. The mapping mechanism according to claim 1, wherein said light emitting member and said light receiving member are provided on a door member of a load port which receives the FOUP thereon and carries wafers accommodated in the FOUP between a predetermined semiconductor fabrication apparatus and the FOUP, the door member facing the lid member of the FOUP to open and close the lid member by upward and downward movement thereof.

4. A Front-Opening Unified Pod (FOUP), comprising:
a wafer receiving section to receive a plurality of wafers placed at a plurality of stage portions thereof in a heightwise direction;
a lid member mounted for opening and closing movement; and
a light path between a light emitting member and a light receiving member provided outside said FOUP, the light receiving member being set to a position at which the light path can cross at least part of the wafers placed at the plurality of stage portions of said wafer receiving section through said lid member,
said lid member having a window member provided on the light path thereon for allowing light to pass through the window member.

5. A load port which can receive a Front-Opening Unified Pod (FOUP) including a wafer receiving section to receive a plurality of wafers at a plurality of stages therein in a heightwise direction and is adapted to carry the wafers accommodated in the FOUP received thereon between the inside of a predetermined semiconductor fabrication apparatus and the inside of the FOUP, said load port comprising:
a light emitting member and a light receiving member for forming therebetween a light path which passes through a window member, which is provided in the FOUP for allowing light to pass through the window member, the light path crossing at least part of the wafers placed on the stage portions of the wafer receiving section.

6. A mapping mechanism for carrying out mapping for a Front-Opening Unified Pod (FOUP) which includes a wafer receiving means on which a plurality of wafers can be placed at a plurality of stages in a heightwise direction and a lid member mounted for opening and closing movement, said mechanism comprising:
light emitting means for outputting light;
light receiving means for receiving light outputted from said light emitting means;
said light emitting means and said light receiving means provided outside the FOUP; and
a window means provided on a light path between said light emitting means and said light receiving means, the light path crossing at least part of the wafers placed on the plurality of stages of the wafer receiving means,
light outputted from said slight emitting means being caused to pass over all of the stages of the wafer receiving means of the FOUP to carry out the mapping for the FOUP.

7. The mapping mechanism according to claim 6, further comprising:
reflection means for reflecting the light outputted from said light emitting means between said light emitting means and said light receiving means so that the light can be inputted to said light receiving means, said window member and said reflection means being provided on the lid member of the FOUP.

8. The mapping mechanism according to claim 6, wherein said light emitting means and said light receiving means are provided on a door member of a load port which receives the FOUP thereon and carries wafers accommodated in the FOUP between a predetermined semiconductor fabrication apparatus and the FOUP, the door member facing the lid member of the FOUP to open and close the lid member by upward and downward movement thereof.

9. A Front-Opening Unified Pod (FOUP), comprising:
wafer receiving means for receiving a plurality of wafers placed at a plurality of stage portions thereof in a heightwise direction;
lid member means mounted for opening and closing movement;
light emitting means for outputting light;
light receiving means for receiving light outputted from said light emitting means; and
a light path between said light emitting means and said light receiving means provided outside said FOUP, the light receiving means being set to a position at which the light path can cross at least part of the wafers placed at the plurality of stage portions of said wafer receiving means through said lid member,
said lid member means having a window member provided on the light path thereon for allowing light to pass through the window member.
